(19) United States
(12) Patent Application Publication
(10) Pub. No.: US 2021/0006768 A1
(43) Pub. Date: Jan. 7, 2021

(54) IMAGE DISPLAY DEVICE, THREE-DIMENSIONAL IMAGE PROCESSING CIRCUIT AND SYNCHRONIZATION SIGNAL CORRECTION METHOD THEREOF

(71) Applicant: Coretronic Corporation, Hsin-Chu (TW)

(72) Inventors: Chih-Hsun Peng, Hsin-Chu (TW); Hsu-Chuan Chen, Hsin-Chu (TW); Yu-Chieh Tsai, Hsin-Chu (TW); Jian-Jiun Wu, Hsin-Chu (TW)

(73) Assignee: Coretronic Corporation, Hsin-Chu (TW)

(21) Appl. No.: 16/916,083

(22) Filed: Jun. 29, 2020

(30) Foreign Application Priority Data
Jul. 2, 2019 (CN) 201910588411.X

(51) Int. Cl. H04N 13/167; G09G 3/20

(52) U.S. Cl. CPC H04N 13/167; G09G 2340/10; G09G 2310/08; G09G 3/20

(57) ABSTRACT

The invention provides a three-dimensional (3D) image processing circuit and a synchronization signal correction method thereof. The 3D image processing circuit is adapted to process a 3D image signal. The 3D image signal includes an image synchronization signal and a view switching signal. The 3D image processing circuit includes a synchronization signal correction circuit coupled to the image processing circuit. A synchronization circuit of the synchronization signal correction circuit receives an image synchronization signal processed by the image processing circuit and simultaneously receives the view switching signal. The synchronization circuit compares the processed image synchronization signal with the view switching signal, so as to output a view switching signal synchronized with the processed image synchronization signal. The invention further provides an image display device including the above 3D image processing circuit.

### CROSS-REFERENCE TO RELATED APPLICATION

This application claims the priority benefit of China application serial no. 201910588411.X, filed on Jul. 2, 2019. The entirety of the above-mentioned patent application is hereby incorporated by reference herein and made a part of this specification.

### BACKGROUND OF THE INVENTION

### 1. Field of the Invention

The invention relates to a three-dimensional image processing technology, and in particular to an image display device, a three-dimensional image processing circuit and a synchronization signal correction method thereof.

### 2. Description of Related Art

With the continuous advancement of display technologies, in order to enhance the visual experience of a user, an image picture viewed by the user begins to change from a two-dimensional (2D) image to a three-dimensional (3D) image. Compared with a conventional 2D image signal, the 3D image signal may include a view switching signal corresponding to the left and right eyes and may additionally include image synchronization signals corresponding to the number of frames. By allowing the left eye and the right eye to receive different views respectively, the user may experience 3D visions of a picture. A current image may be displayed to the left eye or the right eye according to the view switching signal.

However, an image display device may possibly have a frame delay problem when playing a 3D image signal, so that the image synchronization signal and the view switching signal may not be synchronized, which destroys a 3D display effect. This may be resulted from the image path design of a system or different requirements for image processing. For example, a 3D projector may possibly perform image processing operations such as scaling, dynamic compensation, or image correction on a 3D image signal before projecting an image. The processed 3D image signal may possibly have the frame delay problem. Therefore, how to avoid the delay between the image synchronization signal and the view switching signal becomes critical.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The present invention provides an image display device, a three-dimensional (3D) image processing circuit and a synchronization signal correction method thereof, which may automatically synchronize an image synchronization signal with a view switching signal and provide an accurate synchronization effect.

One embodiment of the invention provides a three-dimensional (3D) image processing circuit adapted to process a 3D image signal. The 3D image signal includes an image synchronization signal and a view switching signal corresponding to the image synchronization signal. The 3D image processing circuit includes a synchronization signal correction circuit coupled to the image processing circuit. The image processing circuit receives the image synchronization signal and outputs a processed image synchronization signal, and the synchronization signal correction circuit includes a synchronization circuit. The synchronization circuit is coupled to the output end of the image processing circuit to receive the processed image synchronization signal and simultaneously receive the view switching signal. The synchronization circuit is configured to compare the processed image synchronization signal with the view switching signal, so as to output a corrected view switching signal synchronized with the processed image synchronization signal.

One embodiment of the invention provides a synchronization signal correction method of a three-dimensional (3D) image signal, which is adapted to process a 3D image signal. The 3D image signal includes an image synchronization signal and a view switching signal corresponding to the image synchronization signal. The synchronization signal correction method includes, through an image processing circuit, receiving the image synchronization signal and outputting a processed image synchronization signal. Through a synchronization circuit, the image synchronization signal processed by the image processing circuit is compared with the view switching signal, and a corrected view switching signal synchronized with the processed image synchronization signal is output.

One embodiment of the invention provides an image display device configured to play a three-dimensional (3D) image. The image display device includes a 3D image decoding circuit, an image processing circuit, a synchronization signal correction circuit and an image playing circuit. The 3D image decoding circuit is configured to decode a 3D image signal. The 3D image signal includes an image synchronization signal and a view switching signal corresponding to the image synchronization signal. The image processing circuit is configured to receive the image synchronization signal from the 3D image decoding circuit and output a processed image synchronization signal. A synchronization circuit of the synchronization signal correction circuit is coupled to the output end of the image processing circuit to receive the processed image synchronization signal. The synchronization circuit also receives the view switching signal at the same time. The synchronization circuit is configured to compare the processed image synchronization signal with the view switching signal, so as to output a corrected view switching signal synchronized with the processed image synchronization signal. The image playing circuit is configured to receive the processed image synchronization signal from the image processing circuit and receive the corrected view switching signal from the synchronization signal correction circuit, and play the 3D image signal according to the processed image synchronization signal and the corrected view switching signal.

Based on the above, the image display device, the 3D image processing circuit and the synchronization signal correction method thereof of the invention may be used to compare the processed image synchronization signal with the view switching signal, so as to output the corrected view angle switching signal synchronized with the processed image synchronization signal, so that an automatic synchronization effect between signals may be achieved without manual adjustment by a user, and then high image quality and convenience may be achieved when the user watches the 3D image. In addition, the invention may be used to synchronize the corrected view switching signal with the processed image synchronization signal, thereby reducing the delay time between the processed image synchronization signal and the initial image synchronization signal. The 3D image processing circuit of the invention also has the advantages of a simple structure and an easy integration with an original 3D image processing circuit. The 3D image processing circuit of the invention may be applicable to various 3D image sources, and may be applied to various image display devices.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an image display device according to one embodiment of the invention.

FIG. 2 is a block diagram of a synchronization signal correction circuit according to the embodiment of FIG. 1 of the invention.

FIG. 3 is an oscillogram of processed and unprocessed image synchronization signals and a view switching signal according to one embodiment of the invention.

FIG. 4 is an oscillogram of processed and unprocessed image synchronization signals and corrected and non-corrected view switching signals according to one embodiment of the invention.

FIG. 5 is a flowchart of a synchronization signal correction method of a three-dimensional (3D) image signal according to one embodiment of the invention.

### DESCRIPTION OF THE EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

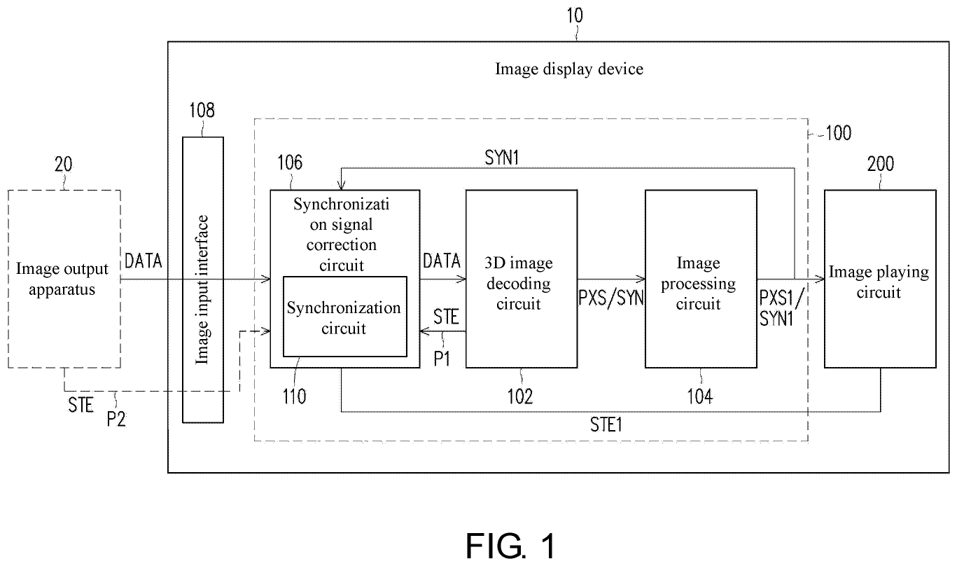

FIG. 1 is a block diagram of an image display device according to one embodiment of the invention. The image display device 10 receives image data DATA from an external image output apparatus 20 to play a three-dimensional (3D) image. The image display device 10 may be a 3D projector, a 3D TV, or other 3D image players. The image output apparatus 20 may be an electronic apparatus such as a smartphone and a notebook computer or a storage medium such as an optical disk and a hard disk. The image display device 10 at least includes a 3D image processing circuit 100 and an image playing circuit 200. The 3D image processing circuit 100 includes a 3D image decoding circuit 102, an image processing circuit 104 and a synchronization signal correction circuit 106.

The 3D image decoding circuit 102 is configured to decode the image data DATA. It should be noted that in the embodiment, the image format of the image data DATA is a 3D image signal, and includes a pixel signal PXS, an image synchronization signal SYN and a view switching signal STE corresponding to the image synchronization signal SYN. After decoding the image data DATA, the 3D image decoding circuit 102 may obtain the pixel signal PXS, the image synchronization signal SYN and the view switching signal STE, and transmits the view switching signal STE to the synchronization signal correction circuit 106, such as an image path P1 in FIG. 1. In another embodiment, the image format of the image data DATA is a two-dimensional (2D) image signal, and the image data DATA may constitute a 3D image signal with another view switching signal STE. The 3D image decoding circuit 102 decodes the image data DATA and then outputs the pixel signal PXS and the image synchronization signal SYN, and the synchronization signal correction circuit 106 receives the view switching signal STE from the image output apparatus 20 through an image input interface 108, such as an image path P2 in FIG. 1.

The image processing circuit 104 is, for example, an image processing chip, and may provide image processing functions such as scaling, motion estimation and motion compensation (MEMC) or keystone correction, blending or warping to adjust a display frame of the 3D image, and the invention does not limit its function type. The image processing circuit 104 receives the pixel signal PXS and the image synchronization signal SYN from the 3D image decoding circuit 102 and outputs a processed pixel signal PXS1 and a processed image synchronization signal SYN1.

The synchronization signal correction circuit 106 includes a synchronization circuit 110. The synchronization circuit 110 is coupled to the output end of the image processing circuit 104 to receive the processed image synchronization signal SYN1 and simultaneously receive the view switching signal STE from the image path P1 or the image path P2. The synchronization circuit 110 compares the processed image synchronization signal SYN1 with the view switching signal STE, so as to output a corrected view switching signal STE1 synchronized with the processed image synchronization signal SYN1. The image playing circuit 200 receives the pixel signal PXS1 and the image synchronization signal SYN1 from the image processing circuit 104, receives the corrected view switching signal STE1 from the synchronization signal correction circuit 106, and plays the 3D image according to the pixel signal PXS1, the image synchronization signal SYN1 and the corrected view switching signal STE1.

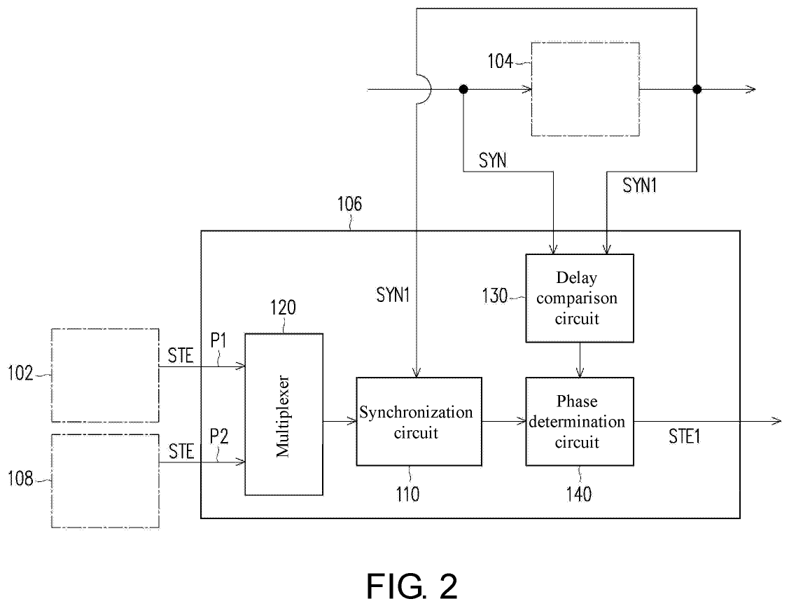

FIG. 2 is a block diagram of a synchronization signal correction circuit according to the embodiment of FIG. 1 of the invention. The synchronization signal correction circuit 106 of FIG. 2 also includes a multiplexer 120, a delay comparison circuit 130 and a phase determination circuit 140 in addition to the synchronization circuit 110. The synchronization signal correction circuit 106 may implement the above structure by using a field programmable gate array (FPGA). Referring to FIG. 2 in conjunction with FIG. 1, the synchronization signal correction circuit 106 is coupled between the 3D image decoding circuit 102 and the image input interface 108.

Specifically, the image input interface 108 is configured to receive the 3D image signal from the image output apparatus 20. The image input interface 108 is, for example, a video graphics array (VGA) interface, a digital visual interface (DVI), a high-definition multimedia interface (HDMI), and a display port (DP) interface or other wired or wireless transmission interfaces that may receive image data.

The multiplexer 120 is coupled to the synchronization circuit 110, the 3D image decoding circuit 102 and the image input interface 108. The multiplexer 120 may selectively receive the view switching signal STE from the image input interface 108 or from the 3D image decoding circuit 102 and the same is provided to the synchronization circuit 110. In other words, when the image format of the image data DATA is a 3D image signal, the view switching signal STE may be transmitted from the 3D image decoding circuit 102 to the multiplexer 120 along the image path P1. When the image data DATA are 2D image data, the multiplexer 120 receives the view switching signal STE from the image output apparatus 20 through the image input interface 108, such as the image path P2. The multiplexer 120 may select a source of the view switching signal STE according to the image format of the image data DATA.

In this way, the image data DATA received by the image display device 10 of the embodiment is not limited to the 3D image format, and another view switching signal STE may be provided and combined with the image data DATA in the 2D image format to display a 3D image.

Particularly, in another embodiment, the synchronization signal correction circuit 106 may not include the multiplexer 120, either, and is not limited to being disposed between the image input interface 108 and the 3D image decoding circuit 102. The synchronization signal correction circuit 106 may be disposed at other positions, but still may receive the processed image synchronization signal SYN1 from the image processing circuit 104 and receive the view switching signal STE from the 3D image decoding circuit 102 or the image input interface 108 to correct the view switching signal STE, so as to output the corrected view switching signal STE1 synchronized with the image synchronization signal SYN1. In addition, the view switching signal STE received by the synchronization circuit 110 may be a view switching signal corresponding to the image synchronization signal SYN1 processed by the image processing circuit 104 or a view switching signal STE corresponding to the image synchronization signal SYN not processed by the image processing circuit 104. The decoded image data DATA are input to the image processing circuit 104 for some image processing steps, and then a delay may occur between the output pixel signal PXS1 and the image synchronization signal SYN1, but the image processing circuit 104 may not actually cause a phase delay in the view switching signal STE, so that in another embodiment, the synchronization signal correction circuit 106 may also receive the view switching signal STE from the output end of the image processing circuit 104.

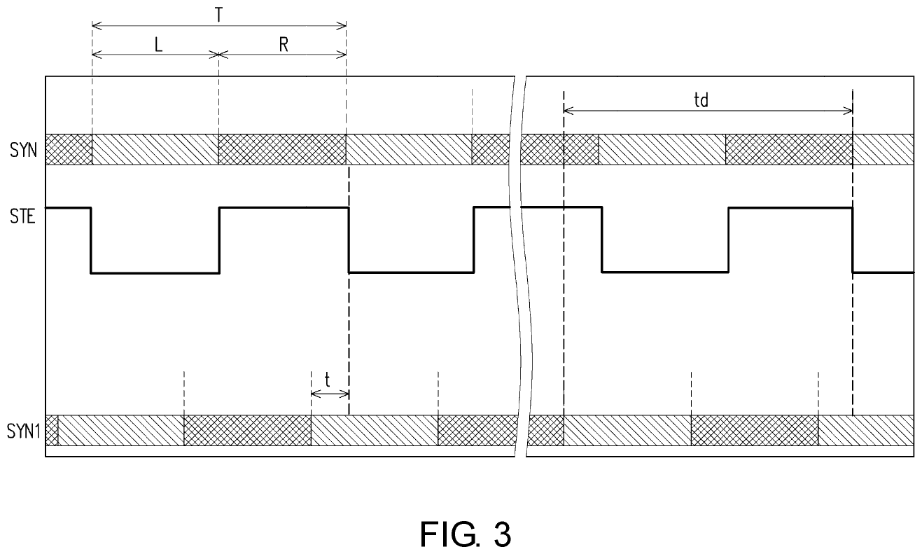

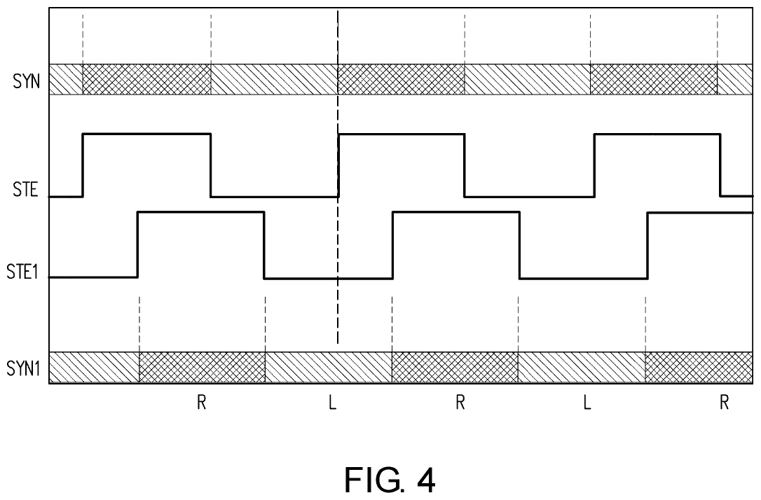

FIG. 3 is an oscillogram of processed and unprocessed image synchronization signals and a view switching signal according to one embodiment of the invention, and FIG. 4 is an oscillogram of processed and unprocessed image synchronization signals and corrected and non-corrected view switching signals according to one embodiment of the invention. Referring to FIGS. 3 and 4, the frame period of the image synchronization signal SYN is T, and the view switching signal STE is at a low level in the period L, for example, a logic “0”, which indicates an image corresponding to the left eye. The view switching signal STE is at a high level in the period R, for example, a logic “1”, which indicates an image corresponding to the right eye. After the signals are processed by the image processing circuit 104, a delay time t may occur between the image synchronization signal SYN and the image synchronization signal SYN1. The synchronization circuit 110 receives the view switching signal STE from the multiplexer 120 and receives the processed image synchronization signal SYN1 from the output end of the image processing circuit 104. The synchronization circuit 110 may compare the frame delay time t between the image synchronization signal SYN1 and the view switching signal STE, that is, the synchronization circuit 110 obtains the frame delay time t by comparing the image synchronization signal SYN1 with the view switching signal STE, and the view switching signal STE is delayed or advanced by the frame delay time, so as to output the corrected view switching signal STE1 synchronized with the processed image synchronization signal SYN1. Therefore, the corrected view switching signal STE1 may be synchronized with the processed image synchronization signal SYN1 by period.

The delay comparison circuit 130 is coupled to the input end and the output end of the image processing circuit 104 to respectively receive the image synchronization signal SYN and the processed image synchronization signal SYN1. The delay comparison circuit 130 may compare the delay time between the image synchronization signal SYN1 and the unprocessed image synchronization signal SYN. The phase determination circuit 140 is coupled to the output end of the synchronization circuit 110 to determine and change the level or phase of the corrected view switching signal STE1 output by the synchronization circuit 110 according to the delay time. Specifically, the corrected view switching signal STE1 output by the synchronization circuit 110 is synchronized with the processed image synchronization signal SYN1 by period, but the logic levels, corresponding to the period L and the period R, of the corrected view switching signal STE1 may be opposite, which causes the result that the left and right eyes receive opposite pictures. A delay time, such as a frame delay time having a size of summarizing the time td in FIG. 3 and N frame periods T, is obtained by comparing a phase difference between the image synchronization signal SYN1 and the image synchronization signal SYN by the delay comparison circuit 130, wherein N is an integer. Whether the level of the corrected view switching signal STE1 corresponds to the correct period R or period L is determined according to the delay time. If the level of the corrected view switching signal STE1 is wrong, the phase determination circuit 140 may change the level or phase of the corrected view switching signal STE1 such that the corrected view switching signal STE1 output by the synchronization signal correction circuit 106 is still at the low level in the period L and at the high level in the period R, and is maintained being synchronized with the processed image synchronization signal SYN1, as shown in FIG. 4.

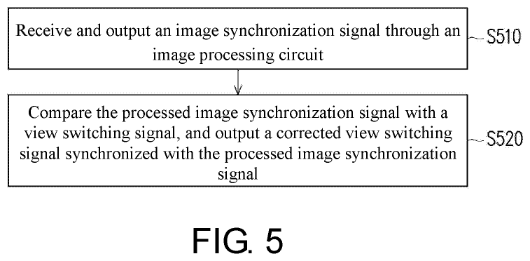

FIG. 5 is a flowchart of a synchronization signal correction method of a three-dimensional (3D) image signal according to one embodiment of the invention. The synchronization signal correction method of FIG. 5 is applicable to the embodiments of FIGS. 1 to 4. The steps of the synchronization signal correction method will be described below in conjunction with the component symbols of the above embodiments.

In Step S510, an image processing circuit 104 receives an image synchronization signal SYN and outputs a processed image synchronization signal SYN1. In Step S520, a synchronization circuit 110 compares the image synchronization signal SYN1 processed by the image processing circuit 104 with a view switching signal STE, and a corrected view switching signal STE1 synchronized with the processed image synchronization signal SYN1 is output. In addition, the operation method of the embodiment of the invention may be described by enough teachings, suggestions and implementations which are obtained in the narrations of the embodiments of FIGS. 1 to 4, and descriptions thereof are omitted herein.

Based on the above, the image display device, the 3D image processing circuit and the synchronization signal correction method thereof of the invention may automatically synchronize the image-processed image synchronization signal with the corrected view switching signal by adjusting the view switching signal. Furthermore, prolonging of the delay time of an image may also be avoided since the processed image synchronization signal is not adjusted. The invention may avoid manual setting of a user for the 3D image, so that convenience in use of the image display device may be improved, and the signals may be accurately synchronized by comparing the image-processed image synchronization signal and the corrected view switching signal. Finally, the invention may be easily combined to main boards of various image display devices thanks to its simple structure. Furthermore, the invention may also be implemented by the FPGA, and has the advantage of low cost.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A three-dimensional (3D) image processing circuit, adapted to process a 3D image signal, wherein the 3D image signal comprises an image synchronization signal and a view switching signal corresponding to the image synchronization signal; the 3D image processing circuit comprises a synchronization signal correction circuit, wherein,
the synchronization signal correction circuit is coupled to the image processing circuit, wherein the image processing circuit receives the image synchronization signal and outputs a processed image synchronization signal, and the synchronization signal correction circuit comprising a synchronization circuit, wherein,
the synchronization circuit is coupled to an output end of the image processing circuit to receive the processed image synchronization signal and simultaneously to receive the view switching signal, the synchronization circuit being configured to compare the processed image synchronization signal with the view switching signal, so as to output a corrected view switching signal synchronized with the processed image synchronization signal.

2. The 3D image processing circuit according to claim 1, wherein the synchronization signal correction circuit further comprises:
a phase determination circuit, coupled to the output end of the synchronization circuit and configured to determine and change a phase or level of the corrected view switching signal output by the synchronization circuit.

3. The 3D image processing circuit according to claim 2, wherein the synchronization signal correction circuit further comprises:
a delay comparison circuit, coupled to an input end and the output end of the image processing circuit and configured to compare a delay time between the processed image synchronization signal and the image synchronization signal unprocessed,
wherein the phase determination circuit determines and changes the phase or level of the corrected view switching signal output by the synchronization circuit according to the delay time.

4. The 3D image processing circuit according to claim 1, wherein the synchronization circuit compares a frame delay time between the processed image synchronization signal and the view switching signal, and the view switching signal is delayed or advanced by the frame delay time, so as to output the corrected view switching signal synchronized with the processed image synchronization signal.

5. The 3D image processing circuit according to claim 1, wherein the synchronization signal correction circuit is implemented by a field programmable gate array (FPGA).

6. The 3D image processing circuit according to claim 1, wherein the synchronization signal correction circuit is coupled between a 3D image decoding circuit and an image input interface, the image input interface being configured to receive the 3D image signal from an image output apparatus, and the 3D image decoding circuit being configured to decode the 3D image signal, so as to output the image synchronization signal to the image processing circuit, wherein the synchronization signal correction circuit further comprises:
a multiplexer, coupled to the synchronization circuit, the 3D image decoding circuit and the image input interface, wherein the multiplexer is configured to selectively receive the view switching signal from the image input interface or the 3D image decoding circuit and to provide the synchronization circuit with the view switching signal.

7. The 3D image processing circuit according to claim 1, wherein the view switching signal received by the synchronization circuit is the view switching signal corresponding to the image synchronization signal processed by the image processing circuit or the view switching signal corresponding to the image synchronization signal not processed by the image processing circuit.

8. A synchronization signal correction method of a three-dimensional (3D) image signal, adapted to process the 3D image signal, the 3D image signal comprising an image synchronization signal and a view switching signal corresponding to the image synchronization signal, wherein the synchronization signal correction method comprises:
through an image processing circuit, receiving the image synchronization signal and outputting a processed image synchronization signal; and
through a synchronization circuit, comparing the processed image synchronization signal processed by the image processing circuit with the view switching signal and outputting a corrected view switching signal synchronized with the processed image synchronization signal.

9. The synchronization signal correction method of the 3D image signal according to claim 8, wherein the synchronization signal correction method of the 3D image signal further comprises:
through a phase determination circuit, determining and changing a phase or level of the corrected view switching signal output by the synchronization circuit.

10. The synchronization signal correction method of the 3D image signal according to claim 9, wherein the synchronization signal correction method of the 3D image signal further comprises:
through a delay comparison circuit, comparing a delay time between the processed image synchronization signal and the image synchronization signal unprocessed, wherein the phase determination circuit determines and changes the phase or level of the corrected view switching signal output by the synchronization circuit according to the delay time.

11. The synchronization signal correction method of the 3D image signal according to claim 8, wherein the step of comparing processed the image synchronization signal processed by the image processing circuit with the view switching signal and outputting the corrected view switching signal synchronized with the processed image synchronization signal comprises:
through the synchronization circuit, comparing a frame delay time between the processed image synchronization signal and the view switching signal, and the view switching signal being delayed or advanced by the frame delay time, so as to output the corrected view switching signal synchronized with the processed image synchronization signal.

12. The synchronization signal correction method of the 3D image signal according to claim 8, wherein the view switching signal received by the synchronization circuit is the view switching signal corresponding to the processed image synchronization signal processed by the image processing circuit, or the view switching signal corresponding to the image synchronization signal not processed by the image processing circuit.

13. An image display device, configured to play a three-dimensional (3D) image, wherein the image display device comprises a 3D image decoding circuit, an image processing circuit, a synchronization signal correction circuit and an image playing circuit, wherein,
the 3D image decoding circuit is configured to decode a 3D image signal, the 3D image signal comprising an image synchronization signal and a view switching signal corresponding to the image synchronization signal;
the image processing circuit is configured to receive the image synchronization signal from the 3D image decoding circuit and output a processed image synchronization signal;
the synchronization signal correction circuit comprises a synchronization circuit, wherein,
the synchronization circuit is coupled to an output end of the image processing circuit to receive the processed image synchronization signal and simultaneously receive the view switching signal, and the synchronization circuit is configured to compare the processed image synchronization signal with the view switching signal, so as to output a corrected view switching signal synchronized with the processed image synchronization signal; and
the image playing circuit is configured to receive the processed image synchronization signal from the image processing circuit and receive the corrected view switching signal from the synchronization signal correction circuit, and play the 3D image according to the processed image synchronization signal and the corrected view switching signal.
